(19) United States
(12) Patent Application Publication
(10) Pub. No.: US 2023/0071047 A1
(43) Pub. Date: Mar. 9, 2023

(54) SYSTEMS AND METHODS FOR VIRTUAL MACHINE RESOURCE DISTRIBUTION

(71) Applicant: MicroStrategy Incorporated, Tysons Corner, VA (US)

(72) Inventors: Herminio CARAMES, Lansdowne, VA (US); Eduardo ABRAHAM, McLean, VA (US); Yifu MA, Fairfax, VA (US); Kewei HU, Broadlands, VA (US); Piotr HAJDUK, Vienna, VA (US)

(73) Assignee: MicroStrategy Incorporated

(21) Appl. No.: 17/469,384

(22) Filed: Sep. 8, 2021

(51) Int. Cl. G06F 9/50; G06F 9/455

(52) U.S. Cl. CPC G06F 9/5077; G06F 9/45558; G06F 9/5016; G06F 2009/4557

(57) ABSTRACT

Disclosed are methods, systems, and computer-readable medium for virtual machine (VM) allocation, including identifying resource availability, allocating a first subset of resource availability to the first user group, generating one or more virtual machines (VMs), for the first user group, the one or more VMs using resources up to the allocated first subset of the resource availability, receiving a request for additional resources, determining that requested additional resources plus the overall allocated resources is less than the resource availability, and allocating the additional resource, based on the determination.

### TECHNICAL FIELD

Various embodiments of the present disclosure relate generally to methods and systems for virtual machine (VM) resource allocation and, more specifically, to initiating or updating VMs based on available and/or assigned resources.

### BACKGROUND

VM initiations are generally controlled based on the number of VMs allocated to a given user (e.g., an individual user, a group of users, etc.). However, such an initiation scheme does not account for the resources used by one or more VMs. For example, a single VM may use the same number of resources as one hundred different VMs. Controlling initiations based on a number of VMs artificially manipulates resource use. Additionally, controlling initiations based on a number of VMs introduces inflexibility in VM initiation based workflows as a result of the non-resource related artificial restrictions.

The present disclosure is directed to overcoming one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems, methods, and computer-readable medium are disclosed for dynamically displaying containers. For instance, a method may include: identifying a central process unit (CPU) availability, a memory availability, and a storage availability; allocating a first subset of the CPU availability to a first user group; allocating a first subset of the memory availability to the first user group; allocating a first subset of the storage availability to the first user group; generating one or more virtual machines (VMs), for the first user group, the one or more VMs using resources up to the allocated first subset of the CPU availability, allocated first subset of the memory availability, and allocated first subset of the storage availability; receiving a request for at least one of an additional CPUs, an additional memory, or an additional storage for the first user group; determining that requested additional CPUs plus an overall allocated CPUs, the requested additional memory plus an overall allocated memory, or the additional storage plus the overall allocated memory is less than the CPU availability, the memory availability, or the storage availability, respectively; and allocating the at least one of the additional CPU, the additional memory, or the additional storage for the first user group, based on the determination.

Furthermore, a system may include at least one memory storing instructions; and at least one processor executing the instructions to perform operations. The operations may include: identifying a central process unit (CPU) availability, a memory availability, and a storage availability; allocating a first subset of the CPU availability to a first user group; allocating a first subset of the memory availability to the first user group; allocating a first subset of the storage availability to the first user group; generating one or more virtual machines (VMs), for the first user group, the one or more VMs using resources up to the allocated first subset of the CPU availability, allocated first subset of the memory availability, and allocated first subset of the storage availability; receiving a request for at least one of an additional CPUs, an additional memory, or an additional storage for the first user group; determining that requested additional CPUs plus an overall allocated CPUs, the requested additional memory plus an overall allocated memory, or the additional storage plus the overall allocated memory is less than the CPU availability, the memory availability, or the storage availability, respectively; and allocating the at least one of the additional CPU, the additional memory, or the additional storage for the first user group, based on the determination.

Moreover, a non-transitory computer-readable medium may store instructions that, when executed by a processor, cause the processor to perform operations. The operations may include: identifying a central process unit (CPU) availability, a memory availability, and a storage availability; allocating a first subset of the CPU availability to a first user group; allocating a first subset of the memory availability to the first user group; allocating a first subset of the storage availability to the first user group; generating one or more virtual machines (VMs), for the first user group, the one or more VMs using resources up to the allocated first subset of the CPU availability, allocated first subset of the memory availability, and allocated first subset of the storage availability; receiving a request for at least one of an additional CPUs, an additional memory, or an additional storage for the first user group; determining that requested additional CPUs plus an overall allocated CPUs, the requested additional memory plus an overall allocated memory, or the additional storage plus the overall allocated memory is less than the CPU availability, the memory availability, or the storage availability, respectively; and allocating the at least one of the additional CPU, the additional memory, or the additional storage for the first user group, based on the determination.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary block diagram of a system, according to one or more embodiments.

FIG. 2A depicts a flowchart for allocating system resources, according to one or more embodiments.

FIG. 2B depicts a flowchart for approving additional resources, according to one or more embodiments.

FIG. 2C depicts a flowchart for performing a system test, according to one or more embodiments.

FIG. 3 depicts a resource allocation diagram, according to one or more embodiments.

FIG. 4A depicts a resource request approval process, according to one or more embodiments.

FIG. 4B depicts a group based resource request approval process, according to one or more embodiments.

FIG. 5 depicts a machine learning model training flow, according to one or more embodiments.

FIG. 6 depicts an example system that may execute techniques presented herein.

### DETAILED DESCRIPTION OF EMBODIMENTS

Various embodiments of the present disclosure relate generally to methods and systems for resource based virtual machine (VM) initialization.

In general, the present disclosure is directed to improving technology used to allocate resources for virtual machines. Implementations disclosed herein are directed to allocating VM resources (e.g., central process units, memory, or storage) based on availability of the resources. Any changes to allocated VM resources may be made based on a request condition and/or based on resource availability. For example, a user may be allocated a given amount of CPUs, memory, and storage based on an available amount of CPUs, memory, and storage. The user may initiate one or any number of VMs based on the allocated amounts of CPUs, memory, and storage.

According to implementations of the disclosed subject matter, resource availability including a CPU availability, a memory availability, and/or a storage availability may be identified. The identification may be based on the amount of physical resources detected by a processor or sensor. Based on the identified resources, a first subset of the CPU availability, a first subset of memory availability, and a first subset of storage availability may be allocated to each of one or more user groups. Based on the allocated resources, one or more VMs may be generated for each of the respective one or more user groups such that the one or more VMs use resources up to the allocated first subset of CPU availability, the first subset of memory availability, and the first subset of storage availability. The one or more VMs may be used for one or more of stability testing, performance testing, certification of an operating system, or the like, or combinations thereof.

A request for additional resources (e.g., additional CPU, additional memory, additional storage, etc.) may be received for a given user group. The request may include a request condition that includes parameters, characteristics, attributes, etc. regarding the request (e.g., the reasons requesting additional resources was necessitated). The request condition may be provided as an input to a machine learning model. The type and/or amount of the additional resources requested may also be provided to the machine learning model. The machine learning model may approve or reject the request based on the request condition and/or type and amount of additional resources.

For an approved request, a determination may be made that the requested resources plus the overall allocated resources are less than the available resources. For example, if five hundred gigabytes are available, four hundred gigabytes are allocated overall (e.g., across multiple user groups), and a user group requests two hundred gigabytes, the requested resources plus the overall allocated resource would exceed the available resources. Consequently, such a request may be denied. Accordingly, those of ordinary skill in the art will recognize that requests for additional resources may be approved, denied, or modified based on resource availability.

If a request is approved or modified, the requested resources may be allocated to the given user group. The allocation may include releasing the respective resources for use by one or more existing VMs for the user group or for the user group to generate one or more additional VMs using the released resources. The releasing may be implemented by modifying access rights of the respective resources such that only VMs associated with the given user group can access the resources.

As applied herein, a user group may be an individual user or a group of users. A group of users may include users that are associated with each other. The association may be based on a department, a company, a temporary or permanent grouping, or the like. The grouping may be designated using an identifier (e.g., a portion of an identifier that identifies a user may be used to identify one or more groups that the user is associated with).

As applied herein, a CPU may include one or more processor and/or may drive components of an electronic system to perform commands (e.g., based on user input, code, etc.). One or more CPUs may be connected to motherboards. A CPU may switch back and forth between various tasks to augment multitasking. This may increase the effective processor speed of the CPU. A given CPU may operate in accordance with an operating system (e.g., an operating system running on a VM). A multi-core CPU may include more than one component. A bus interface component may transfer data to and from the CPU and/or one or more components. A server CPU may provide enterprise level scalability and performance.

As applied herein, a memory may include a device or system that is used to store information for immediate use in a computer or related computer hardware and digital electronic devices. Memory may operate at a high speed compared to storage, as applied herein. Storage may be provide slower access to data in comparison to memory. Contents of memory can be transferred to storage (e.g., via virtual memory). Memory may be implemented as semiconductor memory, where data is stored within memory cells built from MOS transistors on an integrated circuit. Semiconductor memory may include volatile and/or non-volatile memory. Examples of non-volatile memory include flash memory and read-only memory (ROM), programmable read-only memory (PROM), erasable programmable read-only memory (EPROM), electrically erasable programmable read-only memory (EEPROM) memory, and the like. Examples of volatile memory include primary storage such as dynamic random-access memory (DRAM) and fast CPU cache memory such as static random-access memory (SRAM).

Semiconductor memory may be organized into memory cells or bistable flip-flops, each storing one bit (0 or 1). Flash memory organization may include both one bit per memory cell and multi-level cells capable of storing multiple bits per cell. The memory cells may be grouped into words of fixed word length, for example, 1, 2, 4, 8, 16, 32, 64, or 128 bits. Each word can be accessed by a binary address of N bits, making it possible to store 2″ words in the memory. Memory may be implemented locally and/or via a cloud.

As applied herein, storage may be used to retain digital data. The data may be retained in a more long-term manner when compared to memory. Storage may be implemented using one or more magnetic storage devices, one or more optical storage devices, one or more flash devices, one or more solid-state drives, or one or more hard drives. Storage may house applications, operating systems, files, or the like for an indefinite period. Storage may retain data that is preserved with or without power (e.g., preserved through a power-down event). Storage may be implemented locally and/or via a cloud.

As applied herein, a VM may be the virtualization/emulation of a computer system using one or more resources. VMs may be implemented using computer architectures and may provide functionality that is the same as or similar to a physical computing system. A VM may be a system VM or a full virtualization VM such that it substitutes for a physical machine. A system VM may provide functionality for implementing entire operating systems. Multiple VMs running their own guest operating system may be engaged for server consolidation. A hypervisor may be used with a system VM for native execution to share and manage hardware, allowing for multiple environments which are isolated from one another, yet exist using the same resources. A system VM may use hardware-assisted virtualization and/or virtualization-specific hardware from one or more host CPUs. Process VMs may implement programs in a platform-independent environment.

As applied herein, overall allocated resources (e.g., CPUs, memory, storage, etc.) may refer to the total amount of available resources that are allocated to all user groups, combined. The overall allocated resources may change based on providing additional resources or removing resources from one or more user groups. For example, if a first user group of two total user groups is allocated twelve CPUs and a second user group is allocated twenty CPUs, then the overall allocated CPUs is thirty two between the two user groups.

Techniques and systems disclosed herein result in a more efficient VM system by allowing for resource based flexibility. By allocating actual resources (e.g., CPUs, memory, storage, etc.) instead of a non-resource based VM number, a system may optimize the use of resources for use with VM machines. For example, a user group may be limited by actual resources allocated to the user group such that the user group may initiate any number of VMs within the allocated resources. Additionally, the user group may have the flexibility to increase or decrease the number of resources used by a given VM instead of being limited to a pre-determined number of resources per VM. Accordingly, the techniques and systems disclosed herein utilize hardware limits providing software flexibility to a user group.

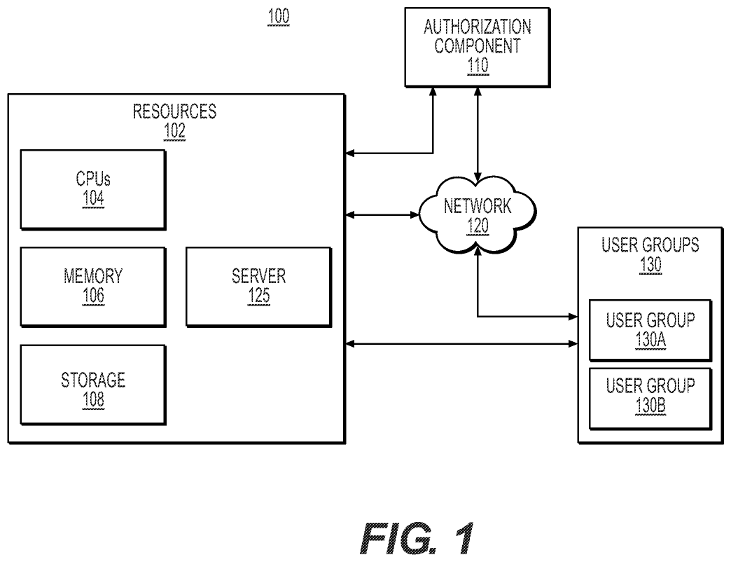

FIG. 1 depicts an exemplary environment 100 in which systems, methods and other aspects of the present disclosure may be implemented. Environment 100 may include resources 102 that include CPUs 104, memory 106, and storage 108. Resources 102 may be managed through server 125, which may communicate with a network 120 in a wired or wireless manner. According to an implementation, server 125 may be a cloud-based server. Resources 102 may be hardware resources that are located in one or more resource locations. Each of the depicted resources (e.g., CPUs 104, memory 106, and storage 108) may be located in the same resources location or may be located in different resource locations. Additionally or alternatively, a subset of each of the resources (e.g., a portion of the overall CPUs) may be located in a first location and a different subset may be located in a second different location.

One or more user groups 130 (e.g., user group 130A, user group 130B, etc.) may be in communication with resources 102 directly or via network 120. User groups 130 may activate VMs using resources 102, as discussed herein. User groups 130 may be provided virtual representations of the computing environments generated through the VMs implemented using resources 102.

An authorization component 110 may include one or more machine learning models. Authorization component 110 may allocate resources 102 for use by user groups 130. Authorization component 110 may determine whether a resource request by one or more user groups in user groups 130 is approved or denied. Accordingly, authorization component 110 may communicate with resources 102 to determine available resources and/or overall allocated resources. Authorization component 110 may communicate with resources 102 directly or via network 120.

Resources 102 (e.g., server 125 associated with resources 102) may connect to a network 120. Server 125 may be implemented using multiple computers that cooperate to perform the functions discussed below, which may be located remotely from each other. Server 125 may be a local server, a remote server, a cloud server, or the like. Network 120 may be any suitable network or combination of networks and may support any appropriate protocol suitable for the communication of data between various components in environment 100. Network 120 may include a public network (e.g., the Internet), a private network (e.g., a network within an organization), or a combination of public and/or private networks.

Environment 100 may include one or more computer systems configured to gather, process, transmit, and/or receive data. In general, whenever environment 100 or components thereof is described as performing an operation of gathering, processing, transmitting, or receiving data, it is understood that such operation may be performed by a computer system thereof.

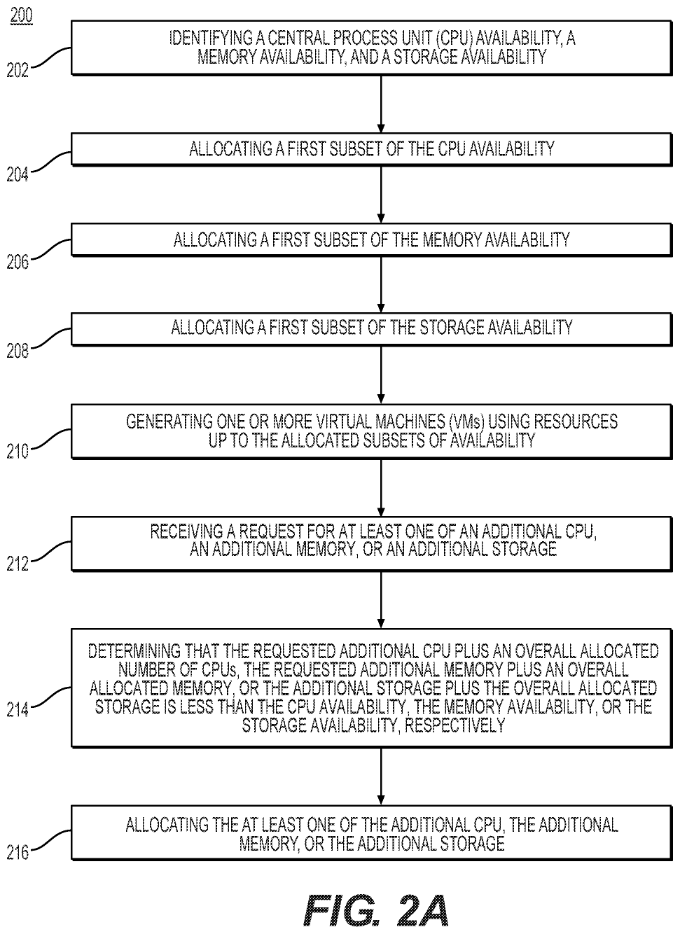

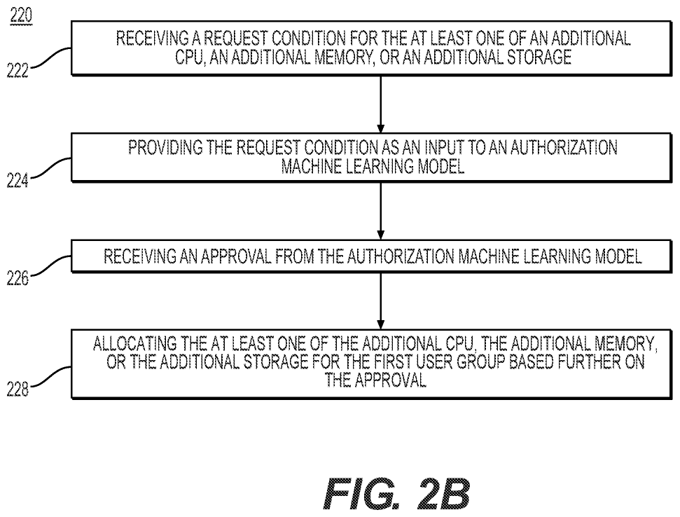

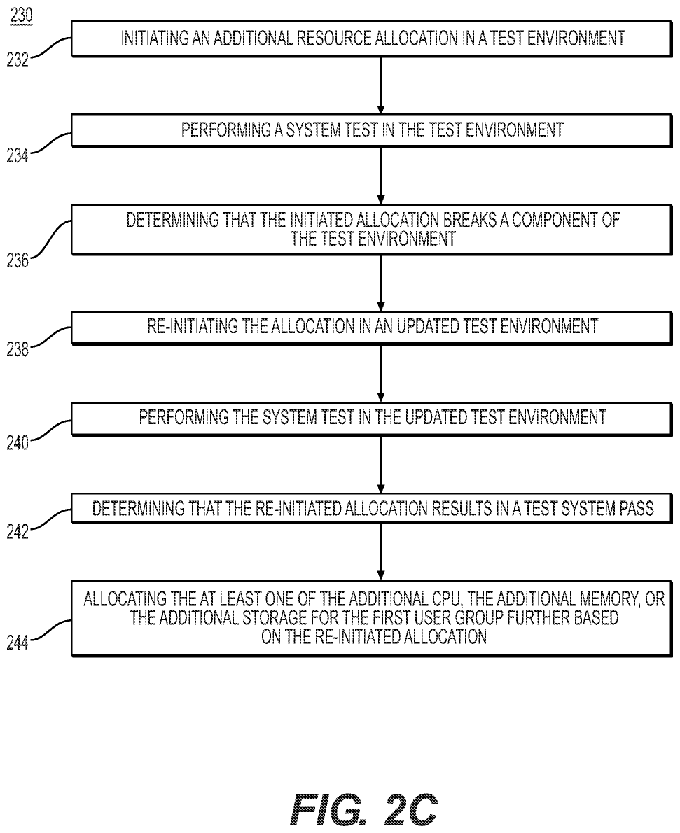

FIG. 2A depicts a flowchart 200 for allocating resources 102 to one or more user groups 130 (e.g., user group 130A, user group 130B, etc.). At 202 of FIG. 2A, resources 102 availability including CPU 104 availability, memory 106 availability, and storage 108 availability may be identified. The identification may be conducted via server 125 and/or authorization component 110. Resource 102 availability may correspond to the overall hardware availability of a given resource (e.g., CPUs 104, memory 106, storage 108, etc.). Accordingly, recourse 102 availability may change based on changes in hardware, hardware being added or removed, temporary or permeant discontinuation of hardware (e.g., due to hardware errors), hardware degradation, or the like.

The identification of resources 102 at 202 of FIG. 2A may be conducted based on signals provided by resources 102. A resource 102 may provide signals indicating resource attributes. For example, a CPU dock may identify the number of CPUs 104 connected as resources 102 based on a connection signal between each respective CPU and the CPU dock. The CPU dock may also receive CPU attributes (e.g., processing power, processing speed, layout, number of processors, etc.) from CPUs 104 via connections between the CPUs 104 and the CPU dock. It will be understood that a CPU dock may be any component that communicates with CPUs 104. Alternatively, each CPU 104 may transmit a signal indicating its attributes and those signals may be received at processor that coordinates resources 102. For example, the processor may be connected to server 125.

Similarly, a memory dock may identify the number of memory 106 units connected as resources 102 based on a connection signal between each respective memory 106 unit and the memory dock. The memory dock may also receive memory attributes (e.g., type of memory, amount of memory per unit, memory configuration, etc.) from memory 106 via connections between the memory 106 and the memory dock. It will be understood that a memory dock may be any component that communicates with memory 106. Alternatively, each memory 106 may transmit a signal indicating its attributes and those signals may be received at processor that coordinates resources 102.

Similarly, a storage dock may identify the number of storage 108 units connected as resources 102 based on a connection signal between each respective storage 108 unit and the storage dock. The storage dock may also receive storage attributes (e.g., type of storage, amount of storage per unit, storage configuration, etc.) from storage 108 via connections between the storage 108 and the storage dock. It will be understood that a storage dock may be any component that communicates with storage 108. Alternatively, each storage 108 may transmit a signal indicating its attributes and those signals may be received at processor that coordinates resources 102.

Resources 102 may be allocated to one or more user groups. Resources 102 may be allocated by a pre-determined schema, based on user input, or by using a machine learning model. Resources 102 may be allocated based on the resource availability identified at 202 of FIG. 2A. Resources 102 may be allocated, for example, via a machine learning model at authorization component 110. The machine learning model may receive one or more user groups 130 as inputs and may determine an optimal amount of resources 102 to allocate to each of the one or more user groups 130. The allocation may be made based on historical use by the one or more user groups 130, based on a hierarchy provided to or determined by the machine learning model (e.g., during training), based on anticipated future needs of the user groups 130 as identified by the machine learning model, or the like. As an example, the machine learning model may identify future needs of one or more user groups 130 based on past use and/or based on future event predictions. The future event predictions may be based on one or more external factors such as current events, trends, or the like. The external factors may be provided to the machine learning model via network 120.

At 204 of FIG. 2A, a first subset of the available CPUs 104 may be allocated to a first user group (e.g., user group 130A, user group 130B, etc.). The first subset of the available CPUs 104 may be different than a second subset of the available CPUs 104 allocated to a second user group different than the first user group. The first subset of the available CPUs 104 may be allocated to the first user group by designating the first subset of the available CPUs 104 for exclusive or semi-exclusive access by the first user group. Semi-exclusive access may be access that is available to a given user group and other non-user group entities. For example, semi-exclusive access may be access shared by a given user group and an administrative group that supports one or more user groups. The first subset of the available CPUs 104 may be allocated to the first user group by updating the software (e.g., via server 125) that controls the first subset of the available CPUs 104 such that the first subset of the available CPUs 104 are configured to be accessed only by the first user group.

Similarly, at 206 of FIG. 2A, a first subset of the available memory 106 may be allocated to a first user group (e.g., user group 130A, user group 130B, etc.). The first subset of the available memory 106 may be different than a second subset of the available memory 106 allocated to a second user group different than the first user group. The first subset of the available memory 106 may be allocated to the first user group by designating the first subset of the available memory 106 for exclusive or semi-exclusive access by the first user group. The first subset of the available memory 106 may be allocated to the first user group by updating the software (e.g., via server 125) that controls the first subset of the available memory 106 such that the first subset of the available memory 106 is configured to be accessed only by the first user group.

Similarly, at 208 of FIG. 2A, a first subset of the available storage 108 may be allocated to a first user group (e.g., user group 130A, user group 130B, etc.). The first subset of the available storage 108 may be different than a second subset of the available storage 108 allocated to a second user group different than the first user group. The first subset of the available storage 108 may be allocated to the first user group by designating the first subset of the available storage 108 for exclusive or semi-exclusive access by the first user group. The first subset of the available storage 108 may be allocated to the first user group by updating the software (e.g., via server 125) that controls the first subset of the available storage 108 such that the first subset of the available storage 108 is configured to be accessed only by the first user group.

At 210, one or more VMs may be generated for or by the first user group. The one or more VMs may be generated using resources up to the allocated first subset of the CPU 104 availability, the allocated first subset of the memory 106 availability, and the allocated first subset of the storage 108 availability. The one or more VMs for the first group may be different than one or more VMs generated for the second group. The one or more VMs generated for the second group may be generated using the resources allocated to the second group which may be independent from the resources allocated to the first group.

According to an implementation, the one or more VMs generated at 210 may use each of a portion of the allocated CPUs 104, memory 106, and storage 108 to operate the one or more VMs. Accordingly, the one or more VMs may have operating capabilities based on the resources allocated to each respective one or more VMs.

At 212 of FIG. 2A, a request for additional resources 102 may be received. The request may be a request for additional CPUs 104, additional memory 106, and/or additional storage 108. The request for additional resources 102 may be received based on user input. Alternatively or in addition, the request for additional resources 102 may be generated automatically.

An automatic request for additional resources may be generated by a resource machine learning model (e.g., at authorization component 110). The resource machine learning model may receive, as input, historical resource data for a given user group or one or more VMs associated with the user group. The resource machine learning model may also receive current resource 102 usage data, changes in resource 102 usage data, and/or information about VM software, use, and functionality, as inputs. The resource machine learning model may generate an output based on one or more of these factors, the output indicating that an additional resource is needed or likely will be needed. Based on a determination that additional resources are needed or likely will be needed, an automatic request for at least one of additional CPUs 104, additional memory 106, and/or additional storage 108, may be generated. As further discussed herein, the request for additional resources may include a request condition. The resource machine learning model may also determine a usage threshold that corresponds to the amount of anticipated usage of one or more resources by a user group.

A request for additional resources may be generated based on a review of current resource 102 use by a given user group. For example, a first threshold amount of a given resource usage amount (e.g., 90%) may raise a first flag (e.g., a color difference, a notification, an alert, etc.) indicating the first threshold amount for a given resource for a given user has been reached. Similarly, a second threshold amount of a given resource usage amount (e.g., 100%) may raise a second flag (e.g., a color difference, a notification, an alert, etc.) indicating the second threshold amount for a given resource for a given user has been reached. The first flag may be different from the second flag. One or more actions may be implemented based on the first flag and/or the second flag. The actions may include, but are not limited to, an automated request for a request condition submission, an automatic request for additional resources, a warning message, a notification to the user group, or the like. For example, an additional resource request may be generated based on determining that a current usage amount exceeds the usage threshold corresponding to the user group using the current resources. The additional resource request may be submitted using an API that facilitates communication with resources 102 and/or authorization component 110.

At 214 of FIG. 2A, a determination may be made whether requested additional resources plus respective overall allocated resources is less than the available resources 102. similar determination may be made for a second user group (e.g., whether resources requested by the second user group plus the respective overall allocated resources are less than available resources 102). A determination may be made whether the requested additional CPUs plus the overall allocated CPUs that are already allocated to user groups is less than the available CPUs 104. As a specific example, if the total available CPUs is one thousand CPUs, and if nine hundred CPUs are already allocated, a determination may be made that a request for one hundred and fifty CPUs plus the allocated nine hundred CPUs (i.e., one thousand and fifty CPUs) would exceed the available CPUs 104 (i.e., one thousand CPUs). A

Similarly, a determination may be made whether requested additional memory plus the overall allocated memory that is already allocated to user groups is less than the available memory 106. Similarly, a determination may be made whether the requested additional storage plus the overall allocated storage that is already allocated to user groups is less than the available storage 108.

If the result of the determination is that the requested additional resource plus the overall allocated resource is less than the available resource 102, then the additional resources may be approved based at least on availability. If the result of the determination is that the requested additional resource plus the overall allocated resource is greater than the available resource 102, then the additional resources may be rejected. An approval based on availability may trigger a request condition based approval determination, as further disclosed herein. However, a rejection based on availability may be an outright rejection, without a further request condition based approval determination. According to an implementation, if a rejection based on availability is made, then a request may be updated or modified to reduce the additional resource request such that it does not exceed available resources.

At 216 of FIG. 2A, additional resources 102 may be allocated to a user group based on the determination at 214 and/or a resource condition based determination, as further disclosed herein. The additional resources may be allocated by updating the access permissions of the additional resources such that they are designated for use by the user group. One or more VMs may be updated or initiated using the additional resources, by the user group. Similarly, additional resources allocated to a second user group may be used by the second user group to initiate or update resources.

FIG. 2B depicts a flowchart for approving additional resources. At 222 of FIG. 2B, a request condition for an additional resource (e.g., additional CPUs, additional memory, additional storage, etc.) may be received. A request condition may include reasons why additional resources should be allocated to a given user group. The reasons may include usage attributes, upcoming use information (e.g., an upcoming resource intensive project identified for the user group), past usage information, software demands based on software changes or growth, operating system demands, testing demands, stability testing demands, performance testing demands, or the like.

A request condition may be received from a user group based on a need for additional resources. Alternatively, as disclosed herein, a resource machine learning model may determine that additional resources are needed and may automatically generate a request condition based on identifying reasons why additional resources are likely to be used in an upcoming time period.

According to an implementation, a system may generate a request for a request condition from a user group or one or more devices or components associated with the user group. The system may generate a request for a request condition based on, for example, a flag indicating that the user group's usage exceeds a threshold. Accordingly, the user group or an electronic or software component associated with the user group may submit the request condition.

At 224, a request condition received at 222 may be provided as an input to an authorization machine learning model. The authorization machine learning model may receive the request condition as well additional information about the user group submitting the request condition, usage of resources 102 by the user group, VM information for VMs operated by the user group. According to an implementation, the authorization machine learning model may receive additional information about usage of resources 102 by one or more user groups in addition the user group submitting the request condition.

The authorization machine learning model may receive the request condition and the additional information and may determine if the request condition meets the rules determined by the authorization machine learning model. The output of the machine learning model may be an approval of the additional resource request, a rejection of the additional resource request, or a modification of the additional resource request, based on the request condition. The rules may be determined during training of the machine learning model, as further discussed herein, or may be based on user input or a system architecture.

At 226 of FIG. 2B, an approval from the authorization machine learning model may be received. At 228, additional resources (e.g., additional CPUs, additional memory, additional storage, etc.) may be allocated to a user group based on the approval at 226 and further based on the determination at 214 that the requested additional resources plus overall allocated resources is less than the available resources.

The resource machine learning model and/or authorization machine learning model may include a plurality of layers and/or a plurality of weights that are configured based on the localization machine learning model's training. The model(s) be configured to receive historical resource data for a given user group or one or more VMs associated with the user group, current resource 102 usage data, changes in resource 102 usage data, information about VM software, use, and functionality, request condition, information about a user group submitting a request condition, usage of resources 102 by a user group, VM information for VMs operated by a user group, usage of resources 102 by one or more user groups, and the like, as inputs. The model(s) may be trained to select a subset of available layers within the model(s) based on the inputs. The resource machine learning model may receive the historical and/or current usage data, and may categorize the current usage data based on analyzing the current usage data in view of the historical usage data. The categorization may be done based on, for example, a percentage of times a simulation based on the current usage data exceeds the available resources allocated to the corresponding user group. Based on the categorization, a subset of the total number of layers of the resource machine learning model may be temporarily disengaged such that the resource machine learning model may determine an output based applying the remaining subset of available layers. Accordingly, the resource machine learning output may be specific to the layers selected based on the categorization. The authorization machine learning mode may disengage and/or engage one or more layers in a manner similar to the resource machine learning model (e.g., disengaging layers that correspond to inapplicable characterizations of request conditions).

Alternatively or additionally, the machine learning model(s) may be trained to adjust one or more weights based on the inputs. For example, the resource machine learning model may receive the historical and/or current usage data, and may categorize the current usage data based on analyzing the current usage data in view of the historical usage data. The categorization may be done based on, for example, a percentage of times a simulation based on the current usage data exceeds the available resources allocated to the corresponding user group. The weights of the resource machine learning model may be adjusted to favor outputs that align with the categorizations. Accordingly, the resource machine learning output may be specific to the weights selected based on the characterization. The authorization machine learning mode may adjust weights in a manner similar to the resource machine learning model (e.g., favoring weights that correspond to inapplicable characterizations of request conditions).

FIG. 2C depicts a flowchart 230 for performing a system test for resource allocation. At 232, an additional resource allocation may be initiated in a test environment. The resource allocation in the test environment may be in response to an additional resource request or may be conducted prior to allocating additional resources at 216 of FIG. 2A. At 234, a system test may be performed in the test environment. The test environment may mimic a real environment and the system test may verify whether allocating additional system resources would result in errors within the test environment.

As an example, allocating additional resources at 216 of FIG. 2A may include modifying resource codes to allocate the additional resources. Prior to committing the code in a real environment, the code may be committed in the test environment. Compiling the code in the test environment may result in a test system failure or break in the test environment at 236 (e.g., based on the additional resources extending beyond available resources, based on the additional resources being incompatible with current resources, based on an error in the code, etc.), test system error, or test system pass. If the result is a test system pass, then the additional resources may be allocated at 244, as further discussed herein.

If the result of compiling the code in the test environment is a test system failure or test system error, at 238 of FIG. 2C, the allocation of the additional resources may be re-initiated in an updated test environment. The re-initiation at 238 may include an update to the additional resource allocation initiated in a test environment at 232 such that the updated test environment at 238 includes a different version of the additional resource allocation. The update may include a different type or number of resources, modifications to the code used to allocate the additional resources, or the like. For example, if the result of performing the system test at 234 is an error, the modification may address the error.

At 240, a system test may be performed in updated test environment. The updated test environment may mimic a real environment and the system test may verify whether allocating additional system resources would result in errors within the updated test environment. At 242, a determination may be made that the re-initiated allocation results in a test system pass. Based on the test system pass, at 244, the additional resources (e.g., CPUs, memory, storage, etc.) may be allocated further based on the test re-initiated allocation (i.e., in addition to the determination at 214 that the requested additional resources plus overall allocated resources is less than the available resources).

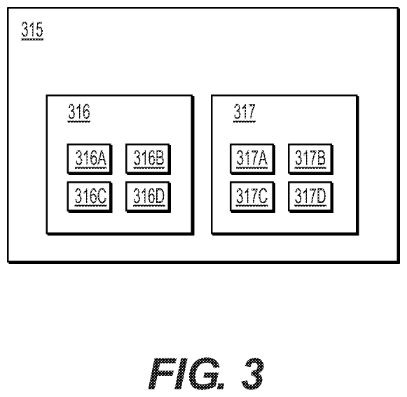

FIG. 3 depicts a resource allocation diagram in accordance with an implementation of the disclosed subject matter. Total available resources 315 correspond to the availability of a given resource (e.g., CPUs 104, memory 106, storage 108, etc.). All or a portion of the total available resources 315 may be distributed amongst a plurality of groups of users (e.g., user group 316, user group 317, etc.). Resources distributed among a given group of users may be allocated amongst multiple users (e.g., 316A, 316B, 316C, 316D, 317A, 317B, 317C, 317D). The allocation amongst multiple users may be predetermined (e.g., each user in a user group may have an equal amount of resources based on the resources distributed to the group, a given user may have more resources allocated to the user than another user in the same group, etc.), or may be undetermined (e.g., a first use first allocation scheme).

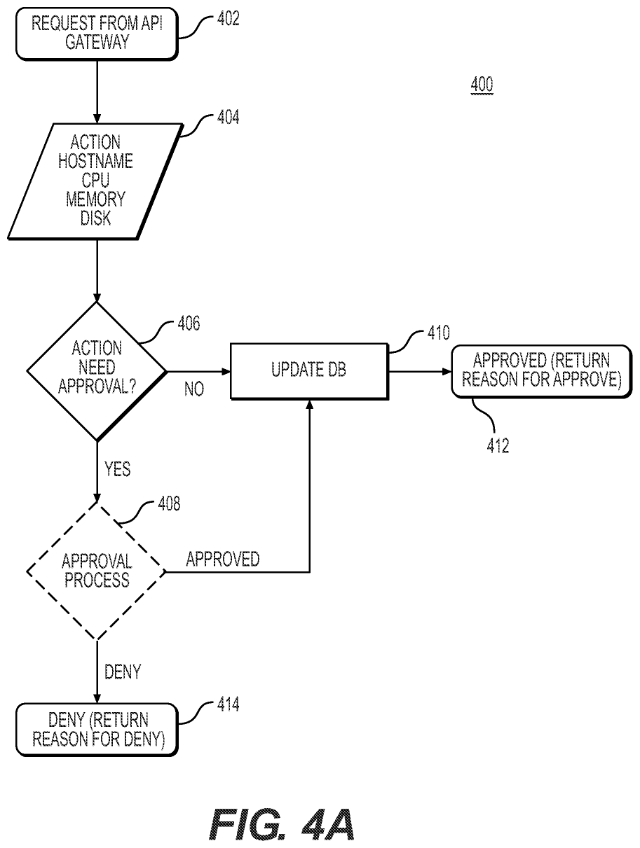

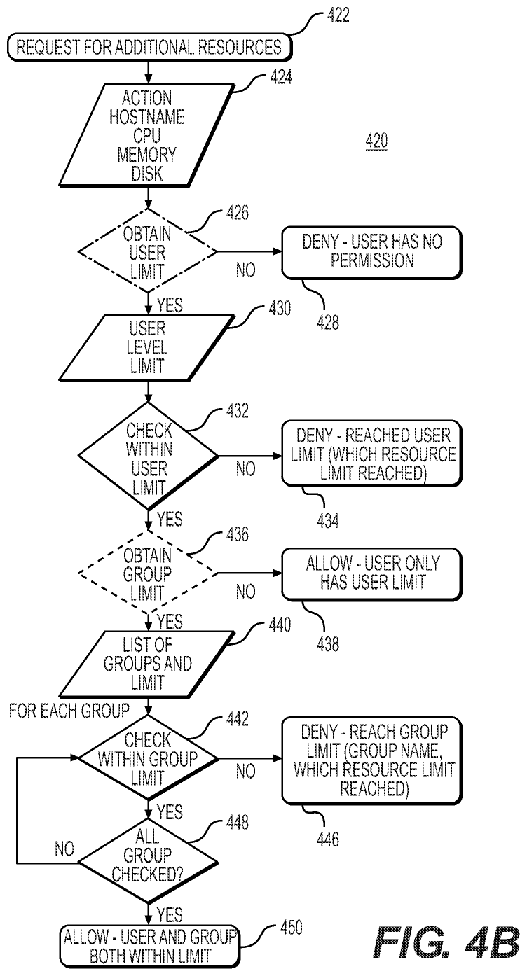

FIG. 4A depicts a resource request approval process 400 in accordance with an implementation of the disclosed subject matter. At 402, an additional resource request 402 may be received via an Application Programming Interface (API) gateway. At 404, information may be extracted from the request. The information may include the action requested (e.g., additional resources), the hostname for a user group, the amount of additional CPUs requested, amount of additional memory requested, and amount of storage (e.g., disk space) requested.

At 406, a determination may be made whether the additional resource request requires approval. The determination may be based on the user group requesting the additional resources (e.g., certain user groups may not require approval), the type or amount of additional resources, or the like. If no approval is required, a database (DB) may be updated at 410 to reflect that the additional resource request is approved and at 412 the approval may be provided to the user group or software requesting the additional resources. If, at 406, a determination is made that the additional resource requests requires approval, then the approval process may be implemented in 408. The approval process may include one or more of the determination of availability of additional resources at 214 of FIG. 2A, the authorization machine learning model implementation of FIG. 2B, and/or the test environments of FIG. 2C. The approval process of 408 may result in a denial of the additional resource request at 414 and may include a reason for the denial as provided to the user group requesting the additional resources and/or a software component associated with the user group. Alternatively, the approval process of 408 may result in an approval and a DB may be updated at 410 to reflect that the additional resource request is approved and at 412 the approval may be provided to the user group or software requesting the additional resources.

FIG. 4B depicts a group based resource request approval process 420 in accordance with an implementation of the disclosed subject matter. At 422, an additional resource request 402 be received (e.g., via an API gateway). The additional resource request 402 may be submitted by a user in a group (e.g., user 316A, 316B, 316C, 316D, 317A, 317B, 317C, 317D of FIG. 3). It will be understood that in some implementations, an additional resource request may be a request for any resources (i.e., the additional resource request need not be in addition to current resources and can be made to receive resources from a user group having no resources). At 424, information may be extracted from the request. The information may include the action requested (e.g., additional resources), the hostname for a user group, the amount of additional CPUs requested, amount of additional memory requested, and amount of storage (e.g., disk space) requested. At 426, a user resource limit may be obtained. The use resource limit may specific to a user that is part of a group (e.g., user 316A, 316B, 316C, 316D, 317A, 317B, 317C, 317D of FIG. 3). Accordingly, the user resource limit obtained at 426 may correspond to the given user that submits the additional resource request 402. If a determination is made, at 426, that the user has a null limit (e.g. no resource permissions), the additional recourse request at 422 may be denied at 428.

At 430, a user limit greater than null may be identified. At 432, a determination may be made whether the additional resource request at 422 is within the user's greater than null limit. If the additional resource request at 422 is not within the user's greater than null limit, then the additional recourse request at 422 may be denied at 434.

At 436, a determination may be made whether a group limit applies to the additional resource request at 422. If no group limit applies, then the user is granted the additional resource request, at 438. If group limits apply, then a list of groups and/or respective limits is obtained at 440. For each group that the user belongs to, a check is conducted to determine if the additional resources requested at 422 would exceed the respective group's limit at 442. If the additional resources requested at 422 would exceed the limit for any of the groups that the user belongs to, at 446, the additional resource request may be denied. According to an implementation, the group name and/or which resource (e.g., CPUs, memory, storage, etc.) limit would be exceeded maybe provided to the user or respective software requesting the additional resources at 422. Once all groups that the given user is associated with are checked (e.g., via the loop at 448), if no group limits are reached, the user may be allocated the requested additional resources at 450.

According to an implementation of the disclosed subject matter, one or more VMs initiated by user groups, and the respective resources associated with the one or more respective VMs may be leased for a given amount of time. The leased amount of time may be determined based on each VM, the user group, a request condition, or the like. The given amount of time may be pre-determined or dynamically determined (e.g., using a machine learning model). Expiration of the leased amount of time may release the resources associated with the VM, thereby disabling the VM. Leasing VMs may ensure discontinuation of stale VMs that may be created for a given task but not released by a user group or associated software after completion of the task.

According to an implementation, a request to prevent expiration of one or more VMs may be received. The request may be generated by a user group or automatically by a software associated with a user group. For example, a user group may require a VM for ongoing testing of an operating system as updates are made to the operating system for an indefinite amount of time. Accordingly, upon approval of the request (e.g., by an authorization machine learning model), the status for the corresponding VM may be updated to a permanent lease status such that the lease does not expire. The permanent lease status may be implemented by automatic lease renewal by updating the lease expiration to a future date, before the expiration of a current lease. Alternatively, the permanent lease status may be implemented by designating a null or infinite lease expiration.

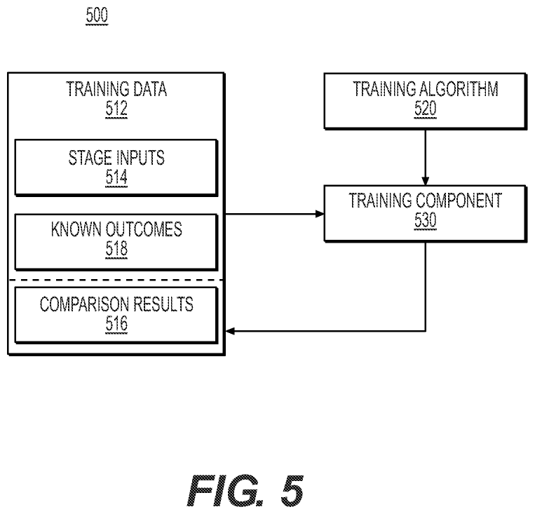

As disclosed, one or more implementations described herein include a machine learning model. A machine learning model disclosed herein may be trained using the data flow 500 of FIG. 5. As shown in FIG. 5, training data 512 may include one or more of stage inputs 514 and known outcomes 518 related to a machine learning model to be trained. The stage inputs 514 may be from any applicable source including usage data, VM type, performance data, etc. (e.g., one or more outputs from a step from flowchart 200 of FIG. 2A, flowchart 220 of FIG. 2B, and/or flowchart 230 of FIG. 2C). The known outcomes 518 may be included for machine learning models generated based on supervised or semi-supervised training. An unsupervised machine learning model might not be trained using known outcomes 518. Known outcomes 518 may include known or desired outputs for future inputs similar to or in the same category as stage inputs 514 that do not have corresponding known outputs.

The training data 512 and a training algorithm 520 may be provided to a training component 530 that may apply the training data 512 to the training algorithm 520 to generate a machine learning model. According to an implementation, the training component 530 may be provided comparison results 516 that compare a previous output of the corresponding machine learning model to apply the previous result to re-train the machine learning model. The comparison results 516 may be used by the training component 530 to update the corresponding machine learning model. The training algorithm 520 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like.

In general, any process or operation discussed in this disclosure that is understood to be computer-implementable, such as the process illustrated in FIGS. 2A, 2B, 2C, etc., may be performed by one or more processors of a computer system, such any of the systems or devices in the environment of FIG. 1 as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

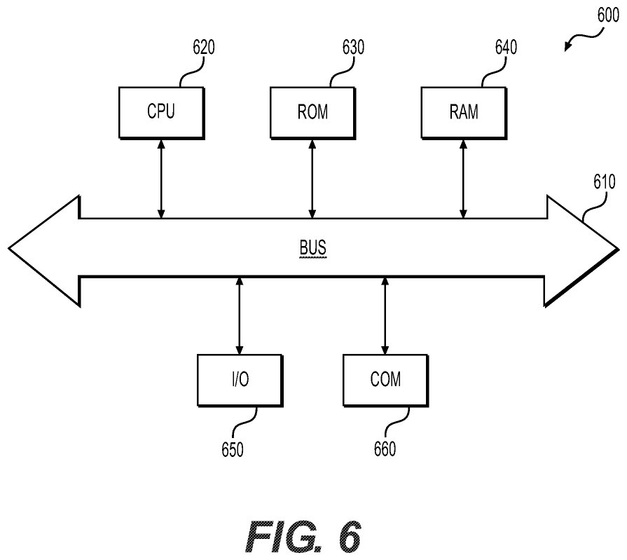

FIG. 6 depicts an example system 600 that may execute techniques presented herein. FIG. 6 is a simplified functional block diagram of a computer that may be configured to execute techniques described herein, according to exemplary embodiments of the present disclosure. Specifically, the computer (or “platform” as it may not be a single physical computer infrastructure) may include a data communication interface 660 for packet data communication. The platform may also include a central processing unit (“CPU”) 620, in the form of one or more processors, for executing program instructions. The platform may include an internal communication bus 610, and the platform may also include a program storage and/or a data storage for various data files to be processed and/or communicated by the platform such as ROM 630 and RAM 640, although the system 600 may receive programming and data via network communications. The system 600 also may include input and output ports 650 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.” As used herein, the singular forms “a,” “an,” and “the” include plural reference unless the context dictates otherwise.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for virtual machine allocation, the method comprising:
identifying a central process unit (CPU) availability, a memory availability, and a storage availability;
allocating a first subset of the CPU availability to a first user group;
allocating a first subset of the memory availability to the first user group;
allocating a first subset of the storage availability to the first user group;
generating one or more virtual machines (VMs), for the first user group, the one or more VMs using resources up to the allocated first subset of the CPU availability, allocated first subset of the memory availability, and allocated first subset of the storage availability;
receiving a request for at least one of an additional CPUs, an additional memory, or an additional storage for the first user group;
determining that requested additional CPUs plus an overall allocated CPUs, the requested additional memory plus an overall allocated memory, or the additional storage plus the overall allocated memory is less than the CPU availability, the memory availability, or the storage availability, respectively; and
allocating the at least one of the additional CPU, the additional memory, or the additional storage for the first user group, based on the determination.

2. The method of claim 1, wherein allocating the at least one of the additional CPU, the additional memory, or the additional storage for the first user group further comprises:
receiving a request condition for the at least one of an additional CPU, an additional memory, or an additional storage;
providing the request condition as an input to an authorization machine learning model configured to output a request approval or request denial based on the request condition;
receiving an approval from the machine learning model; and
allocating the at least one of the additional CPU, the additional memory, or the additional storage for the first user group based further on the approval.

3. The method of claim 1, where the memory is one of flash memory, read-only memory (ROM), programmable read-only memory (PROM), erasable programmable read-only memory (EPROM), or electrically erasable programmable read-only memory (EEPROM) memory.

4. The method of claim 1, wherein the storage is at least one of a hard-drive storage, cloud storage, server storage, or database storage.

5. The method of claim 1, wherein the one or more VMs expire after a leased amount of time.

6. The method of claim 5, further comprising:
receiving a request to prevent expiration of the one or more VMs; and
modifying the one or more VMs to have a permanent lease status.

7. The method of claim 6, wherein the permanent lease status is implemented by an automatic lease renewal.

8. The method of claim 1, wherein the one or more VMs are configured to perform one or more of stability testing, performance testing, or certification of an operating system.

9. The method of claim 1, wherein receiving the request for at least one of the additional CPU, the additional memory, or the additional storage comprises determining that a current usage amount exceeds a usage threshold.

10. The method of claim 9, wherein the usage threshold is determined by a machine learning model.

11. The method of claim 10, further comprising:
generating a resource request based on determining that the current usage amount exceeds the usage threshold; and
submitting the resource request via an application programming interface (API).

12. The method of claim 1, further comprising:
allocating a second subset of the CPU availability to a second user group;
allocating a second subset of the memory availability to the second user group;
allocating a second subset of the storage availability to the second user group; and
generating one or more second VMs, for the second user group, the one or more second VMs using resources up to the allocated second subset of the CPU availability, allocated second subset of the memory availability, and allocated second subset of the storage availability.

13. The method of claim 1, wherein allocating the at least one of the additional CPU, the additional memory, or the additional storage for the first user group further comprises:
initiating the allocation in a test environment;
performing a system test in the test environment;
determining that the initiated allocation breaks a component of the test environment;
re-initiating the allocation in an updated test environment;
performing the system test in the updated test environment;
determining that the re-initiated allocation passes the system test; and
allocating the at least one of the additional CPU, the additional memory, or the additional storage for the first user group further based on the re-initiated allocation.

14. A system for virtual machine allocation, the system comprising:
at least one memory storing instructions; and
at least one processor executing the instructions to perform operations, the operations comprising:
identifying a central process unit (CPU) availability, a memory availability, and a storage availability;
allocating a first subset of the CPU availability to a first user group;
allocating a first subset of the memory availability to the first user group;
allocating a first subset of the storage availability to the first user group;
generating one or more virtual machines (VMs), for the first user group, the one or more VMs using resources up to the allocated first subset of the CPU availability, allocated first subset of the memory availability, and allocated first subset of the storage availability;
receiving a request for at least one of an additional CPUs, an additional memory, or an additional storage for the first user group;
determining that requested additional CPUs plus an overall allocated CPUs, the requested additional memory plus an overall allocated memory, or the additional storage plus the overall allocated memory is less than the CPU availability, the memory availability, or the storage availability, respectively; and
allocating the at least one of the additional CPU, the additional memory, or the additional storage for the first user group, based on the determination.

15. The system of claim 14, wherein allocating the at least one of the additional CPU, the additional memory, or the additional storage for the first user group further comprises:
receiving a request condition for the at least one of an additional CPU, an additional memory, or an additional storage;
providing the request condition as an input to an authorization machine learning model configured to output a request approval or request denial based on the request condition;
receiving an approval from the machine learning model; and
allocating the at least one of the additional CPU, the additional memory, or the additional storage for the first user group based further on the approval.

16. The system of claim 14, wherein allocating the at least one of the additional CPU, the additional memory, or the additional storage for the first user group further comprises:
initiating the allocation in a test environment;
performing a system test in the test environment;
determining that the initiated allocation breaks a component of the test environment;
re-initiating the allocation in an updated test environment;
performing the system test in the updated test environment;
determining that the re-initiated allocation passes the system test; and
allocating the at least one of the additional CPU, the additional memory, or the additional storage for the first user group further based on the re-initiated allocation.

17. The system of claim 14, further comprising an authorization component configured to authorize the request for at least one of the additional CPUs, the additional memory, or the additional storage based on a request condition.

18. A non-transitory computer-readable medium storing instructions that, when executed by a processor, cause the processor to perform operations, the operations comprising:
identifying a central process unit (CPU) availability, a memory availability, and a storage availability;
allocating a first subset of the CPU availability to a first user group;
allocating a first subset of the memory availability to the first user group;
allocating a first subset of the storage availability to the first user group;
generating one or more virtual machines (VMs), for the first user group, the one or more VMs using resources up to the allocated first subset of the CPU availability, allocated first subset of the memory availability, and allocated first subset of the storage availability;
receiving a request for at least one of an additional CPUs, an additional memory, or an additional storage for the first user group;
determining that requested additional CPUs plus an overall allocated CPUs, the requested additional memory plus an overall allocated memory, or the additional storage plus the overall allocated memory is less than the CPU availability, the memory availability, or the storage availability, respectively; and
allocating the at least one of the additional CPU, the additional memory, or the additional storage for the first user group, based on the determination.

19. The non-transitory computer-readable medium of claim 18, wherein allocating the at least one of the additional CPU, the additional memory, or the additional storage for the first user group further comprises:
receiving a request condition for the at least one of an additional CPU, an additional memory, or an additional storage;
providing the request condition as an input to an authorization machine learning model configured to output a request approval or request denial based on the request condition;
receiving an approval from the machine learning model; and
allocating the at least one of the additional CPU, the additional memory, or the additional storage for the first user group based further on the approval.

20. The non-transitory computer-readable medium of claim 18, wherein allocating the at least one of the additional CPU, the additional memory, or the additional storage for the first user group further comprises:
initiating the allocation in a test environment;
performing a system test in the test environment;
determining that the initiated allocation breaks a component of the test environment;
re-initiating the allocation in an updated test environment;
performing the system test in the updated test environment;
determining that the re-initiated allocation passes the system test; and
allocating the at least one of the additional CPU, the additional memory, or the additional storage for the first user group further based on the re-initiated allocation.
